(19) United States
(12) Patent Application Publication
(10) Pub. No.: US 2012/0166414 A1
(43) Pub. Date: Jun. 28, 2012

(54) SYSTEMS AND METHODS FOR RELEVANCE SCORING

(75) Inventors: Scott Decker, Los Angeles, CA (US); Matthew Kumin, Los Angeles, CA (US); Jeffrey Horowitz, Los Angeles, CA (US); Christopher Oliver, Los Angeles, CA (US)

(73) Assignee: Ultra Unilimited Corporation (dba Publish), Sherman Oaks, CA (US)

(21) Appl. No.: 13/345,520

(22) Filed: Jan. 6, 2012

Related U.S. Application Data
(63) Continuation-in-part of application No. 12/228,254, filed on Aug. 11, 2008.

(51) Int. Cl. G06F 17/30

(52) U.S. Cl. 707/709; 707/738; 707/723; 707/E17.014; 707/E17.089; 707/E17.108

(57) ABSTRACT

Systems and methods for relevance scoring are provided. Traditional scoring models use word frequency and placement to determine relevance. In contrast to these models, embodiments of the present invention provide cluster-based relevance scoring and tagging. Some embodiments use various cluster mappings and vector space models to generate relevance scores. In addition, the cluster mappings can be updated overtime to reflect a change in topic clustering.

### CROSS REFERENCE TO RELATED APPLICATIONS

This application is a continuation-in-part of U.S. patent application Ser. No. 12/228,254, which was filed on Aug. 11, 2008 and claims the benefit of U.S. Patent Application No. 60/955,117, which was filed on Aug. 10, 2007, titled “Method for Retrieving and Editing HTML Documents,” their entire contents are hereby incorporated herein by reference for all purposes.

### TECHNICAL FIELD

Various embodiments of the present invention generally relate to tagging content to facilitate advanced searching capabilities. More specifically, various embodiments of the present invention relate to systems and methods for cluster-based relevance scoring using vector space models.

### BACKGROUND

HTML is the language typically used to write web pages. The HTML language specifies a fixed number of tags or containers that encapsulate content such as text and images. These tags tell the browser general information about the nature of the content, for example, if it is part of a paragraph, a table, or whether or not the text should be in bold, italics, etc. In addition, tags may contain attributes that tell the browser specific information about that tag. Some examples include the display size, whether there should be a border, and how to align contained text. HTML documents may contain grammatical mistakes and still be displayed flawlessly by a web browser. In addition, an author of an HTML page may not specify where a tag ends, making it ambiguous as to whether a certain section of a document is part of a table, a paragraph, etc.

In addition to HTML tags that are used for building HTML pages, there are other types of tags that provide metadata for searching. However, traditional tagging systems and methods that generate the metadata for searching use word frequency and word placement within the web page to determine relevance. Evaluating the relevance of a document based on word frequency and placement can sometimes be misleading. As such, there are a number of challenges and inefficiencies found in traditional tagging and searching algorithms.

### SUMMARY

Systems and methods are described for tagging content with a topic based relevance score to facilitate advanced searching capabilities. In some embodiments, a method for tagging content first includes generating a vector space of word sequences from content. The content can, for example, be extracted from a web page (e.g., using a web crawler) or other document. A second vector space of topic clusters associated with the content can then be generated from the word sequences extracted from the content. In some embodiments, generating the second vector space of topic clusters includes determining a relevance distribution (e.g., by using a voting algorithm) of the topic clusters to the content and removing one or more of the topic clusters from the second vector space. Then, the content can be tagged based on a relevance scoring vector generated by projecting the first vector space of word sequences into the second vector space of topic clusters. In some embodiments, the content can be tagged using a topical tag based on a cosine similarity of the content to the second vector space of topic clusters.

The method may include generating a set of topical clusters associated with a text sequence having a plurality of entries (e.g., that have been isolated from a document and/or text extracted from a web page). Then, a topical score for each topical cluster can be generated. In some cases, the topical score is generated by each entry in the text sequence assigning a vote to one of the topical clusters. From the set of topical clusters and the topical score, a relevance score can be computed for each of the plurality of entries in the text sequence.

Various embodiments of the present invention also include computer-readable storage media containing sets of instructions to cause one or more processors to perform the methods, variations of the methods, and other operations described herein.

The systems provided by various embodiments can include a topic cluster database, an isolation engine, a natural language parsing module, a sequence generator, a query module, a disambiguation module, a scoring module, and/or a tagging module. The topic cluster database can be used to store a plurality of entries that are each associated with one or more topic clusters. In various embodiments, the database includes a list of synonyms for each entry and, for each query, the database also associates topical clusters associated with the synonyms (e.g., alias and/or patterns) of the entry.

The isolation engine can be configured to receive content and generate, using a processor, a first series of proper names found within the content. A proper name can include any reference to a person, an event, a significant date, a movie, a song, a musical group, a book, a play, a social group, a company, an internet address, an activity, city, state, country, any other place, thing, or reference of interest. In some embodiments, the isolation engine can include a natural language parsing module to generate the first series of proper names using a natural language algorithm searching for proper names. The isolation engine can also include a sequence generator to generate n-grams from the content. In one embodiment, a query module can be communicably coupled to the isolation engine and configured to access the topic cluster database to determine a second series of topic clusters related to the first series of proper names.

A disambiguation module can be used, in some embodiments, to determine a topical relevance of the second series of topic clusters to the content and remove one or more unrelated topic clusters from the second series of topic clusters based on the topical relevance. The disambiguation module uses a vector space model to determine the relevance. A scoring module can be configured to receive the first series of proper names and the second series of topics clusters and generate relevance scores (e.g., by using vector space functions). Then, the tagging module can tag the content based on the relevance scores generated by the scoring module.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present invention will be described and explained through the use of the accompanying drawings in which:

FIG. 1 is a schematic depicting an overall architecture of the system, according to one or more embodiments of the present invention;

FIG. 2 is a flow diagram depicting an exemplary process for retrieving, formatting, and displaying an HTML document in accordance with some embodiments of the present invention;

FIGS. 3A and 3B show screen shots of an example of a website according to various embodiments displaying an article from another websites;

FIG. 4 shows a block diagram with exemplary components of relevance tagging module in accordance with one or more embodiments of the present invention;

FIG. 5 is a flow chart illustrating exemplary ranking operations for operating a relevance tagging system in accordance with various embodiments of the present invention;

FIG. 6 is a flow chart illustrating exemplary operations for creating a topic rank in accordance with some embodiments of the present invention;

FIG. 7 is a flow chart illustrating exemplary operations for tagging content in accordance with one or more embodiments of the present invention;

FIG. 8 is a flow chart illustrating exemplary operations for tagging content in accordance with various embodiments of the present invention; and

FIG. 9 illustrates an example of a computer system with which some embodiments of the present invention may be utilized.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Various embodiments of the present invention generally relate to automatically tagging content with a cluster-based relevance score. More specifically, various embodiments of the present invention relate to systems and methods for generating cluster-based relevance scores using vector space models. Traditional tagging systems and methods use word frequency and word placement to tag content. However, a text document may really feature a particular person, but may mention other persons and things. In contrast to these models, embodiments of the present invention provide for a relevance score based on a natural clustering of topics within the content. The scoring based on natural clustering allows for more accurate tagging not available in traditional systems.

In some embodiments, identified text sequences (e.g., proper names) found within a text document or other content can be matched with proper names in a database. The database provides a connection or interrelationship between the entries of the text sequence to one or more topics. Then, for example, using vector space models the relevance of the matched entries to the text document can be determined. A matching of one of the text entries and the relevance score to the content or text document is called a tag.

Various embodiments of techniques described herein use tagging algorithms with one or more of the following features: 1) a mathematical model that projects a vector space of proper names into a vector space of topics associated to those proper names; 2) a process of mapping a text document into a set of disambiguated topics (e.g., by removing homonyms) 3) ranking those topics in terms of relevance; and 4) a mathematical model of applying a vector space to the natural clustering of topics to determine relevancy of the clusters to a document. In one embodiment, a highly relevant topic can be labeled as a featured topic and a moderately relevant topic can be labeled as a mention.

In some embodiments, systems and methods for generating vector spaces for proper names and topics are provided and 1-to-1 functions are defined that map or project the proper names into the topics. The 1-to-1 functions allow for disambiguation and relevance scoring. The vector space applications used in the techniques described herein serve the purpose of uniquely identifying the topics in a document, and determining how relevant the topics are to the document. The relevance score for a topic to a document can include the cosine similarity of that topic's vector with the disambiguated topic vector, and hence the document.

Once the relevance scoring vector has been determined, a cluster vector representing the natural clustering of topics with one another can be generated. The cluster can be used for disambiguation (e.g., during a voting process). In some embodiments, a normalized cluster vector can be formulated from the cluster's member topics. The dot product of the relevance scoring vector and the normalized cluster vector gives the relevance score of the cluster to the document also in the form of the cosine similarity.

Each of these relevance scores facilitate advanced searching of content by tagging content with what is most relevant in that content. This dramatically differs from search based on keywords only and page organizations to satisfy search engine ranking algorithms. These features and advantages, along with others, found in various embodiments make improved content searching available through cluster-based relevance scoring and tagging.

The techniques introduced here can be embodied as special-purpose hardware (e.g., circuitry), or as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

### Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to various embodiments,” “in the embodiments shown,” “in one embodiment,” “in other embodiments,” and the like generally mean the particular feature, structure, or characteristic following the phrase is included in at least one embodiment of the present invention, and may be included in more than one embodiment of the present invention. In addition, such phrases do not necessarily refer to the same embodiments or to different embodiments.

If the specification states a component or feature “may”, “can”, “could”, or “might” be included or have a characteristic, that particular component or feature is not required to be included or have the characteristic.

The term “responsive” includes completely or partially responsive.

The term “module” refers broadly to software, hardware, or firmware (or any combination thereof) components. Modules are typically functional components that can generate useful data or other output using specified input(s). A module may or may not be self-contained. An application program (also called an “application”) may include one or more modules, or a module can include one or more application programs.

### General Description

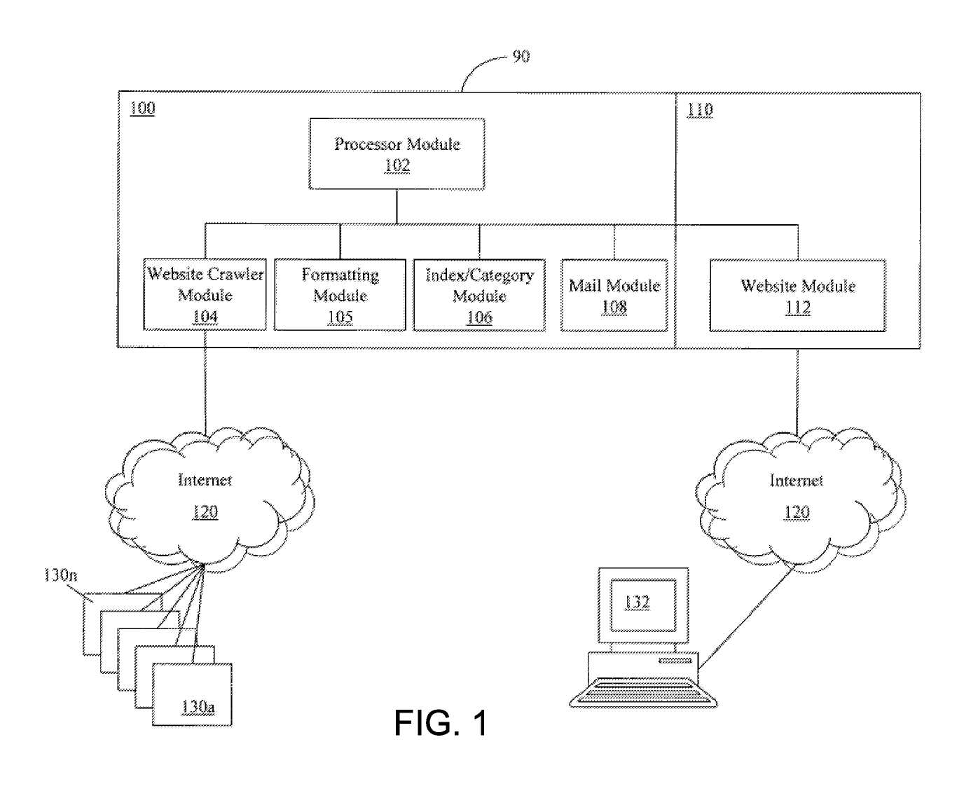

FIG. 1 shows a system 90 for retrieving, formatting, indexing/categorizing, and displaying web content to a user. The system 90 includes a backend module 100 and a front end module 110. The backend module 100 includes a processor 102, a website crawler module 104, a formatting module 105, an index/categorizing module 106, and a mail module 108. The front end module 110 includes a website module 112. The website crawler module 104 retrieves data via the Internet 120 from a plurality of websites 130a . . . 130n. Under control of the processor 102, data retrieved by the website crawler 104 formatted by the formatting module 105 and then indexed and categorized by the index/categorizing module 106. The indexed and categorized data is provided to the website module 112 of the front end 110 to enable a user can to access/view the information on a remote terminal 132 via the Internet 120. In some instances, the user can setup a personal account on the system 90 though the website module. One advantage of setting up a personal account is to enable the user to instruct the system 90 email personalized data to the user via the mail module 108.

In some embodiments, a plurality of source websites can be researched and tagged as being related to a predetermined subject. For example, several source websites can be researched and tagged as being a source for articles, text, or information relating to a specific sports team, college, or an overall sport. Other examples can include subjects such as politics, medicine, news, celebrities, etc. Such tagging can be a “top level tagging process.” Data such as articles or text can be retrieved from these tagged source websites. In some embodiments, the data is retrieved every hour to update the information relating to predetermined subject matter. A parsing algorithm can be used to filter the content of the data. For example, an HTML text or article document can be parsed to limit the text to the core textual contents of the article. In some embodiments, the ads, menus, and extra text from the web page HTML document are removed so that the article can be displayed with such ads, menus or extra text. The data retrieved from the source websites and parsed/filtered can be stored in a queue to be refined by another process.

An indexing/categorizing module 106 places data in a working index to be indexed and categorized. In some embodiments, the working index is a database index. In some embodiments, the data can be taken at a predetermined interval (such as every hour) and copied into a work area. An algorithm can be used to remove texts or articles duplicative of other texts and/or articles. In some embodiments, certain articles and/or data are tagged as being related to a specific subject, such as a particular team, player or sport. If the articles and/or data are not tagged, queries can be made to determine which articles or data relates to a specific subject. In some embodiments, the queries are formulated to determine when the text of an article is predominately focused on the specific subject. Related articles and/or data taken from the various web pages or sources can be indexed by being mapped and grouped with one another.

The website module 112, according one embodiment, can have two sub-systems including a website running index and a website cache. The website module 112 can run off the website running index for all its articles and can provide the required coding for data display. When the indexing process is done, the website module 112 updates the website running index. The website module 112 can cache the website running index in the background through the website cache and swap the cache for the website module 112 thereby allowing the website module 112 to operate without any “downtime”.

In some embodiments, users of the website can create an account and setup a daily email service. The mail module 108 can use a script to check the website database to determine the users who need to have an email sent. The mail system module 108 can access the website module 112 for the user's account and send to the user updated data such as articles and/or text.

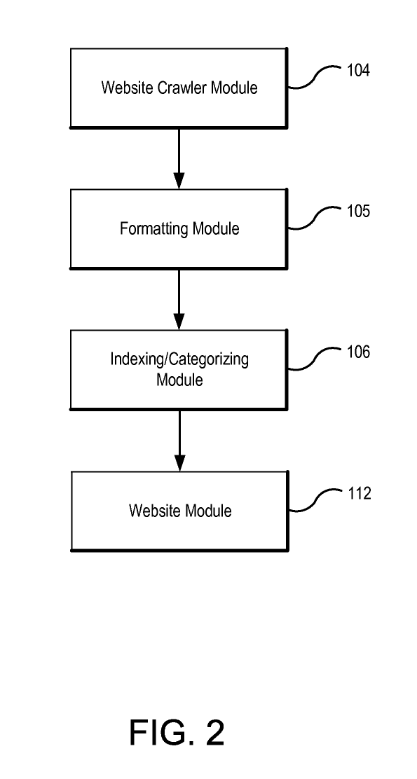

FIG. 2 represents a flow diagram depicting the process for retrieving and formatting an HTML document through the above described system 90 (FIG. 1). The website crawler module 104 retrieves data from at least one source. In some embodiments, the website crawler module 104 retrieves an HTML document from an external web source from the Internet 120 (FIG. 1). The formatting module 105 can format the HTML document to limit the text of the HTML to the “core text” of the article. After the formatting module 105 formats the HTML document, the indexing/categorizing module 106 adds the HTML document to a working index so that the article/text can be mapped and categorized.

The website crawler module 104 can retrieve data such as an HTML document from an external source website. In some embodiments, a plurality of sources are mapped to predetermined subjects, such as source websites that focus on specific sports, teams or a colleges. Sources can be mapped to a predetermined subject if it is known that a source predictably provides articles or text on the subject. For example, if it is known that a specific source website always talks about a specific sports team, it may not be necessary to perform algorithms to ascertain the subject matter of the article.

After the website crawler module 104 retrieves an HTML document, the formatting module 105 formats the HTML document. In some embodiments, the formatting module 105 formats the HTML document to remove menus, ads, and other extra text that is not related to the subject matter of the article text itself. In the case of an HTML document, an algorithm can be used to balance the HTML and remove common HTML from the document. In some embodiments, script tags, style tags, “br” tags, “hr” tags, “param” tags, “embed” tags, object tags and “&rsquo” tags are removed from the HTML document. In some embodiments, colons (:) from the document are replaced with an “_x” because using colons in HTML documents can present problems when an HTML parser is used. An HTML parser can then be used to balance all the tags in the documents, so that each tag in the HTML document has both a start and a stop. In some embodiments, HTML comments are removed from the document.

The formatting module 105 can also run the HTML document through a printer, such as a prettyprinter that presents the document in such a way that is more easily readable to the user. In some embodiments, the prettyprinter can use a specific algorithm to reformat the text of the document. For example, the printer can place a new line after a “td” tag, “div” tag, “ul” tag, or “p” tag. Shorten on-click events can be used for “a href” tags up to a predetermined number of characters, such as 40 characters. In some embodiments, once a tag has been captured, if the tag is a “b” tag, “ahref” tag, “em” tag, “I” tag, “font” tag, “span” tag, “img” tag, or strong tag, no line is added but lines are added after the other tags. Bullets, “&bull”, “&nsbp”, and “\\n” items can be replaced with a space.

After the formatting module 105 runs the HTML document through the printer, the document can be reformatted to limit the text of the document to the “core text” of the document. Limiting the document to the core text of the document can mean limiting the document to the article itself or limiting the document to the text of the document that discusses the specific subject of the article. In some embodiments, lines of text that do not make up the core text of the articles are removed. Certain lines of text can be ignored and remain in the document. In some embodiments, lines with text comprising the words “Copyright”, “Terms of Service”, “Place your ad”, “Trackback”, “Sidebar”, or “Author” are kept in the document. In some embodiments, if a line starts with “Comments”, it may be desirable to wait to find the ending tag because the “Comments” have nothing to do with the core text of the article. Including “Comments” makes it difficult to find related articles, since those other articles do not have the same “Comments.” To determine which lines of text should be removed from the document, the printed HTML document can be taken and a ratio of the HTML tag length to the regular text length can be calculated for each line. If the ratio of the HTML to regular text is less than a predetermined value, then it can be assumed that the line is a text line, and it should remain in the document. In some embodiments, the ratio can be about 0.375. Once all the lines are reviewed and a determination is made as to whether the line should be removed or kept based on the calculated ratio or the text of the line itself, all the lines are gathered and stored as the “core text” of the article.

The indexing/categorizing module 106 can store the HTML document in a working index. In some embodiments, the categorizing/indexing module 106 stores articles with associated data such as a publication date, images associated with the article, and whether the document came from a local, national or video source. If it can be determined that the article is related to a specific subject, such as a specific team, sport, or college, the article can be mapped in the working index.

The indexing/categorizing module 106 adds the HTML document to a working index of HTML documents including articles from different web sources relating different subject matter. The indexing/categorizing module 106 filters the working index to remove duplicates and categorized HTML documents to organize the documents relating to a specific subject or topic. After the indexing/categorizing module 106 de-duplicates and categorizes the HTML documents in the working index, the website module 112 updates the website running index and website cache.

Once the indexing/categorizing module 106 adds an article to the working index of HTML documents, the working index can be de-duplicated. In some embodiments, the de-duplication process involves finding a title of an article and searching for any titles that are within one word of an exact match of the similar terms. By way of example, if an article has the title “Cowboys take the Super Bowl” a query of similar terms can bring up matches such as “Super Bowl taken by Cowboys” or “Cowboys take the Bowl.” In some embodiments, if the word count of the title is longer than 5 words, a percentage closeness match can be done. Given the length of the title, titles with the same words are found, but the length can be a predetermined percentage, such as 80%, for there to be a match. If there is a match, then it can be assumed that it is likely a duplicate title and/or article. In some embodiments, duplicate articles found by using such an algorithm are removed from the working index.

The working database index of HTML documents can contain a plurality of articles and text that relate to varying subject matter. The indexing/categorizing module 106 can group or map the HTML documents according to the subject matter of the article. In some embodiments, algorithms can be used to find and categorize articles or text relating to a specific subject, such as a sports team or player. The level of detail required for a query can depend on the level of specificity of the mapped subject matter of an article. If an article is grouped by a specific subject matter, then a less focused query can be used. If an article is grouped by a broad topic, however, a focused query can be used. For example, if an article is already mapped to a specific subject, such as a team or a player, the article is more likely to be displayed for that specific subject. If the article's source has been pre-mapped with a specific group of tags, it is more likely to then be displayed for that tag grouping. An article's source needs to match certain queries, but those queries are much more loose, because the source mapping is trusted.

If an article is mapped to a focused but nonspecific subject, the query can be loosened. For example, if an article is mapped to a team and an article needs to be found regarding a specific player on the team, a loosened query can be used based upon the last name of the player. If the last name of the player is found in an article mapped to the team, then it is likely an article about that player. In some embodiments, the full name of the player may be searched to confirm the relevancy of the article.

If an article is mapped to a less specific subject, then a more detailed query can be run. For example, if an article is only mapped to a college, the query should not have keywords relating to any sports other than the specific sport that the user is interested in. This can be done to prevent retrieving articles that talk about unrelated sports teams from that college. In some embodiments, additional search terms are used to focus the query. For example, it can be a requirement that the name of one of the players from the college appear in the article.

If the article is mapped to a broad umbrella topic, then a strict, detailed query can be run. For example, if an article is mapped to a general sport, then the query must be appropriately fashioned. In the case of national sports teams, no national teams have duplicate names. Therefore, if an article is mapped to a national sport, if the name is mentioned in the title, it can likely be assumed that the subject matter of the article relates to that team. An example of a strict query includes ensuring that team names are in the articles or titles along with specific player queries.

Once all of the articles in the working index have been tagged, the indexing/categorizing module 106 can use an algorithm can be used to map articles related to one another. In some embodiments, articles and data retrieved over a predetermined interval can be combined into the working index. For example, articles and data retrieved in the past three (3) days can be taken from the website's running index and combined with the articles retrieved from the web sources. If data is retrieved hourly from external web sources, this can provide three (3) days and one (1) hour worth of content. With the articles combined from the working index and the website's running index, a query can be run to find related articles. In some embodiments, parameters such as the host of the web source and comparisons of the text can be used to perform the query. In some embodiments, the text of the articles must match up to a predetermined threshold percentage for it to be tagged as a related article. For example, if an article is from the same host, then the text of the articles must be highly similar to match the criteria. If the text of the articles match up to approximately 80%, then the articles can be tagged as being related to one another.

Once the indexing/categorizing module 106 tags and maps the HTML document in the working index, the website module 112 can update the website running index. The website module 112 adds the tagged working indexes to the website running index. In some embodiments, new additions are added to the working index, as well as mapping ones that had been mapped before. In one embodiment, the searcher/index process is run on an hourly basis. In the previous hour, articles are found that are related with each other. In the next hour, an article may be found that is related to just one of the previously found articles. Next, the article that is related is used to find all of its related articles and all of these articles should also be related to this new article we just found. The website module 112 can also add the items that are related to the other articles to the working index. After the indexes have been updated, the website module 112 commands the website to load the updated working index in the background. Once the updated working index is uploaded, the website module 112 switches the caches to point to the updated website running index.

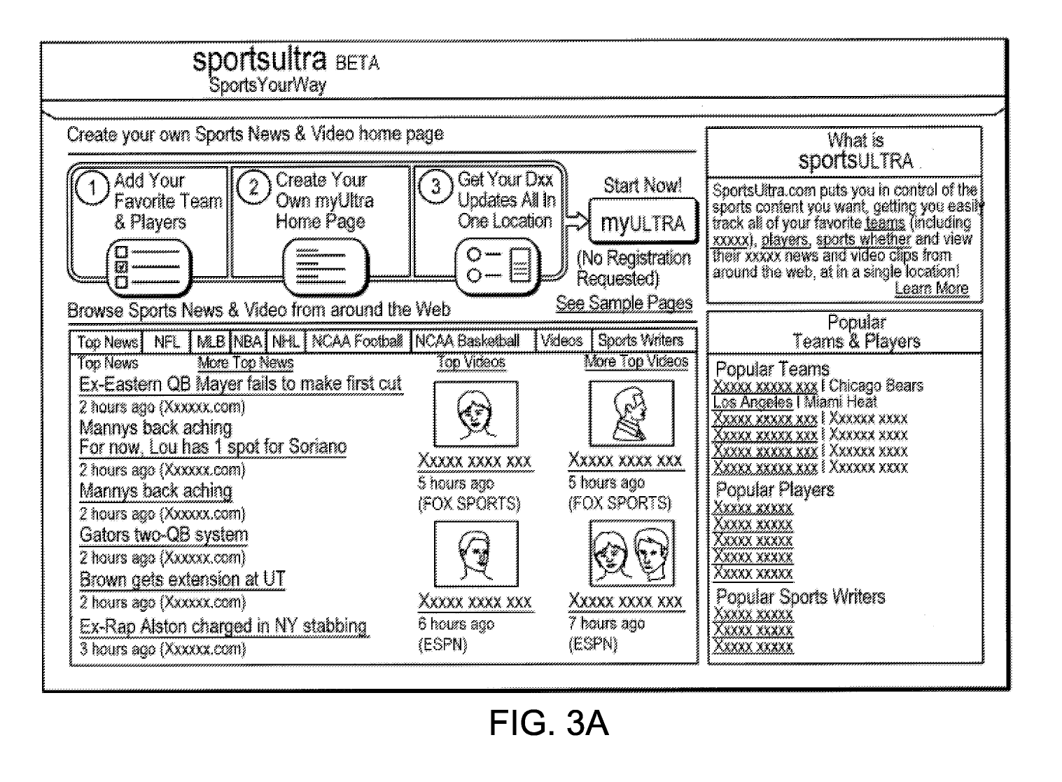

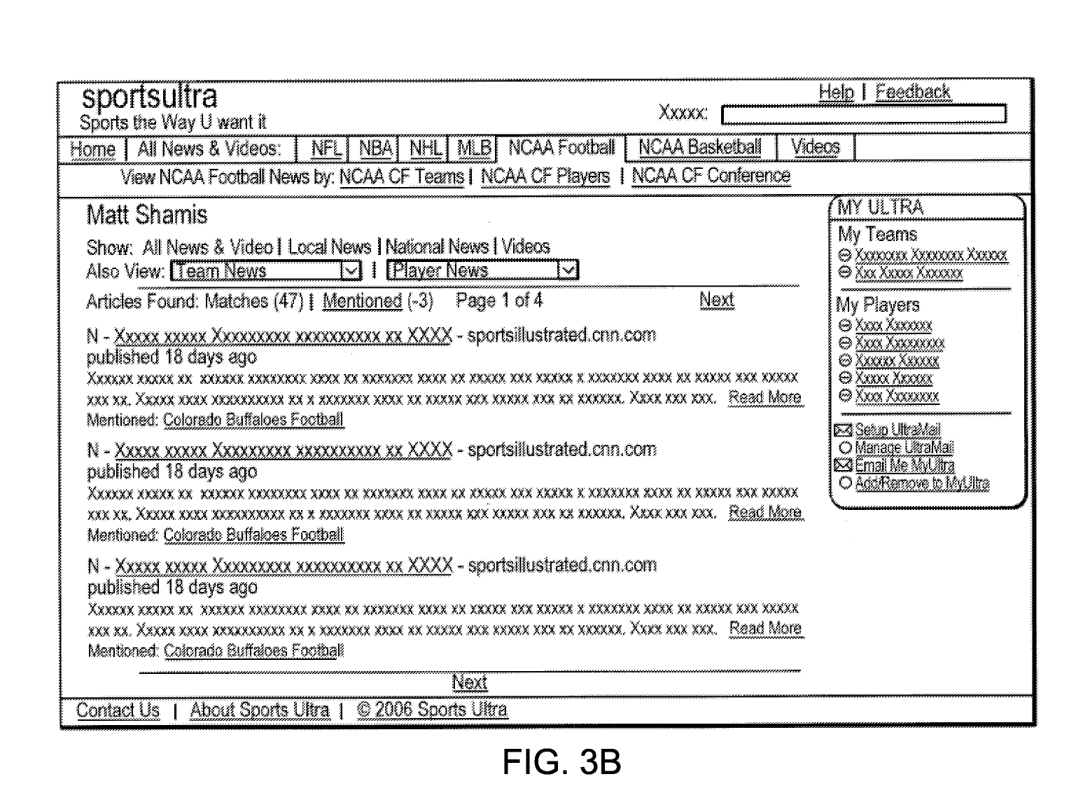

FIGS. 3A and 3B are screenshots of the website, according to one embodiment. As can be seen in FIG. 3A, the website allows a user to create pages to receive news and updates relating to their preferred sports teams, players, etc. The sports teams or players that the user chooses can be used as a predetermined subject to retrieve and locate related articles and information in the website running index. As discussed above in FIGS. 1-2, these articles can be retrieved from external source websites, reformatted, mapped and categorized to be displayed using the website as shown in FIG. 3A.

FIG. 3B shows how a user can go on to the website and pick a player to retrieve relevant articles and information about that player. As can be seen, the website provides a link to the external source website that published the article. The website can also provide the user with the “core text” of the article.

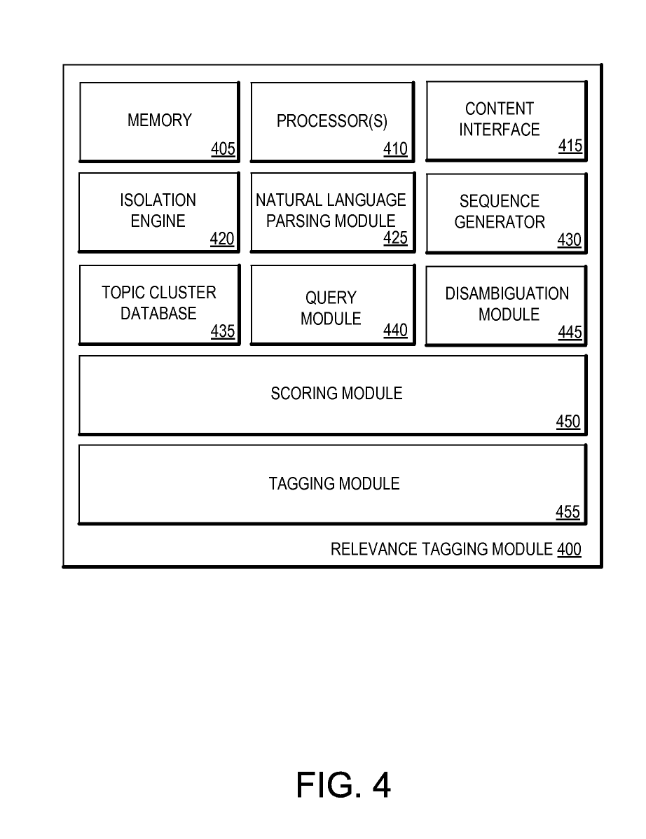

FIG. 4 shows a block diagram with exemplary components of relevance tagging module 400 in accordance with one or more embodiments of the present invention. The relevance tagging module 400 can be used for relevance based tagging of content and may be, for example, part of indexing and categorization module 106. In some embodiments, relevance tagging module may be part of a search engine.

According to the embodiments shown in FIG. 4, the relevance tagging system can include memory 405, one or more processors 410, content interface 415, isolation engine 420, natural language parsing module 425, sequence generator 430, topic cluster database 435, query module 440, disambiguation module 445, scoring module 450, and tagging module 455. Other embodiments of the present invention may include some, all, or none of these modules and components along with other modules, engines, interfaces, applications, and/or components. Still yet, some embodiments may incorporate two or more of these elements into a single module and/or associate a portion of the functionality of one or more of these elements with a different element. For example, in one embodiment, natural language parsing module 425 and sequence generator 430 can be combined with isolation engine 420.

Memory 405 can be any device, mechanism, or populated data structure used for storing information. In accordance with some embodiments of the present invention, memory 405 can encompass any type of, but is not limited to, volatile memory, nonvolatile memory and dynamic memory. For example, memory 405 can be random access memory, memory storage devices, optical memory devices, media magnetic media, floppy disks, magnetic tapes, hard drives, SIMMs, SDRAM, DIMMs, RDRAM, DDR RAM, SODIMMS, erasable programmable read-only memories (EPROMs), electrically erasable programmable read-only memories (EEPROMs), compact disks, DVDs, and/or the like. In accordance with some embodiments, memory 405 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 405.

Memory 405 may be used to store instructions for running one or more modules, engines, interfaces, and/or applications on processor(s) 410. For example, memory 405 could be used in one or more embodiments to house all or some of the instructions needed to execute the functionality of content interface 415, isolation engine 420, natural language parsing module 425, sequence generator 430, topic cluster database 435, query module 440, disambiguation module 445, scoring module 450, and/or tagging module 455.

Content interface 415, in accordance with one or more embodiments of the present invention, manages and translates any tagging requests received from a user (e.g., received through a graphical interface screen) or application into a format required by the destination component and/or system. For example, content interface may extract desired content from a web page or use an optical character recognition (OCR) application to generate a text document for analysis. Once the content has been generated, isolation engine 420 receives the content and generates a first series of text sequence (e.g., series of proper names) found within the content.

In some embodiments, the natural language parsing module 425 generates a series of proper names. The proper names can be any word or phrase that identifies an activity, an event, a place, an action, a group, a date, a title (e.g., a title of a song or movie), a product, or any other identifier of interest. In some embodiments, the NLP module 425 may also identify co-references to any of the identifiers. The identification of the co-references can include an association of pronouns with the proper names using context. Traditional natural language parsers, typically, are good at recognizing people, but can fail short in identifying other identifiers. For example, traditional natural language parsers are not good at identifying complex proper names (e.g., movie or book titles, especially those with sequels and parts). In addition, other proper names such as song titles, theater arts titles or even titles of events (such as conferences, sporting events, concerts and so forth) can be difficult for natural language parsers.

Various embodiments of the present invention can also include sequence generator 430. Sequence generator 430 can be used to generate n-grams by identifying capitalized words within the content and taking the next n-words. The series of n-grams can then be combined (e.g., by a union operation) to create the first series of proper names which can used to query topic cluster database 435 to identify a series of topic clusters related to the proper names using query module 440. Database 435 can include, for example, a list of synonyms (e.g., aliases and patterns) for each entry. In some embodiments, for each query the database also associates topical clusters associated with the synonyms.

Disambiguation module 445, in some embodiments, can use a vector space model to determine correct topics for the proper names or word sequence returned from isolation engine 420. For example, disambiguation module 445 can determine a topical relevance (e.g., by using a voting algorithm) of the second series of topic clusters to the content. Then, one or more unrelated topic clusters can be removed from the second series of topic clusters based on the topical relevance.

Scoring module 450 can be configured to receive the first series of proper names and the second series of topics clusters as inputs. From these inputs scoring module 450 can generate relevance scores. These relevance scores can be used by tagging module 455 to tag the content based on the relevance scores.

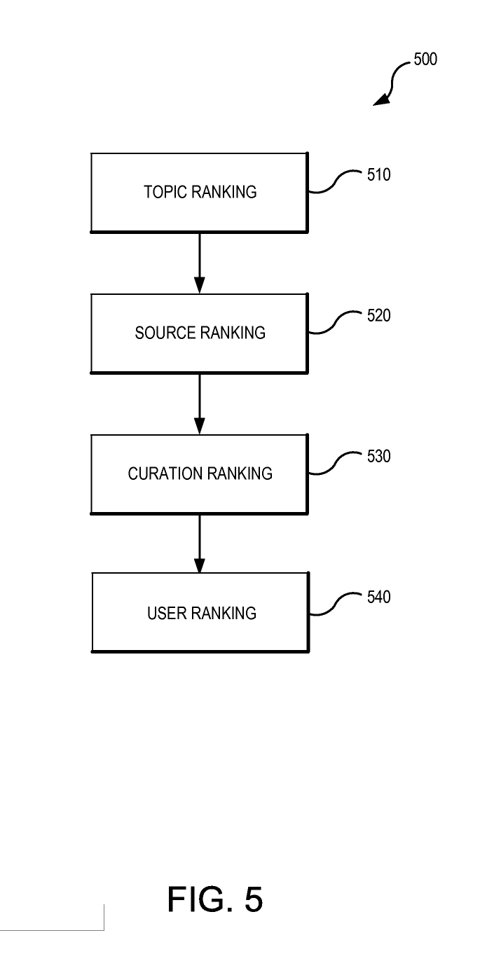

FIG. 5 is a flow chart illustrating exemplary ranking operations 500 for operating a relevance tagging system in accordance with various embodiments of the present invention. In accordance with some embodiments, one or more of these operations can be performed by the tagging system and components described herein. As illustrated in FIG. 5, topic ranking operation 510 can generate a topic rank based on clustering of text sequences extracted from the document or content. The clustering can be identified using mapping of extracted text sequences. Then, the clustering can be disambiguated to remove any irrelevant clusters (e.g., those derived by homonyms) before a relevance score is generated using vector space models.

Source ranking operation 520 identifies the source of the content and assigns a weighting which can be used to improve the disambiguation of the natural clusters. Curation ranking operation 530 creates aggregate sets and mappings based on the content people are picking from various searches. These aggregated sets and mappings can be used by topic ranking 510 for weighting, disambiguation, scoring, tagging, and other purposes. User ranking operation 540 can create additional aggregate sets and mappings based user ranking of content.

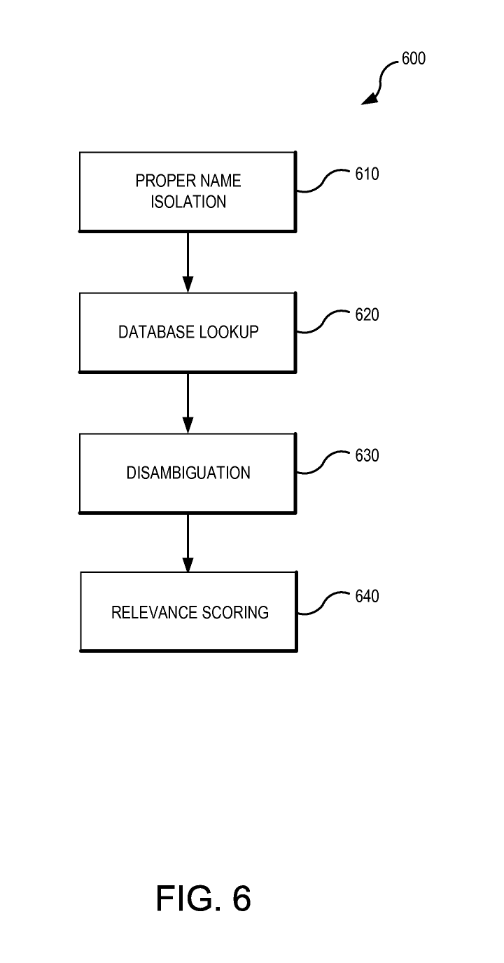

FIG. 6 is a flow chart illustrating exemplary operations 600 for creating a topic rank in accordance with some embodiments of the present invention. In accordance with various embodiments, the operations illustrated in FIG. 6 can be performed, for example, by isolation engine 420, natural language parsing module 425, sequence generator 430, query module 440, disambiguation module 445, scoring module 450, and/or tagging module 455.

Isolation operation 610 generates a list of text sequences from a text document or other content. The output of isolation operation 610 can be used as an input to a cluster generation system. In accordance with various embodiments, the text sequence can be found using a natural language parsing application to isolate named entities and their co-references. In addition n-word sequences (e.g., 2 and 3 word sequences) can also be generated to supplement the natural language parsing application. An n-gram is a sequence of words in the text document or content for which the first word is capitalized. For example, the text “The movie ‘To Kill a Mocking Bird is interesting’.” may produce these 2-grams and 3-grams:

2-grams: the movie, to kill, kill a, mocking bird, bird is; and

3-grams: the movie to, to kill a, kill a mocking, mocking bird is, bird is interesting

In some embodiments, the list of text sequences produced by proper name isolation includes the unique union of the proper names found though the natural language parser and the n-grams.

Database lookup operation 620 finds all matches to elements in the list output generated by proper name isolation operation 610 within a database of proper names. The database of proper names can be purchased from a third-party and may be updated periodically. In other cases, the database can be generated based on information retrieved from other users or from analysis of a subset of various sources. In some cases, the database may actually include multiple databases from different sources with different entries and interrelationships. Each of the databases can include an appropriate data model that can be queried with the proper names in the list. For example, in some embodiments, the database contains proper names and their interrelationships. Within the database, a proper name is referred to as a topic. For example, “Kobe Bryant” and “Lamar Odom” are basketball players on the roster of the “Los Angeles Lakers”. This example includes three topics and one relationship between them (roster).

A document or other content may not always contain a perfect match for a topic. To facilitate lookup for imperfect proper name matching, various embodiments of the database may contain synonyms for each topic which can include of aliases and patterns for each topic. An alias for a topic is also a proper name, but may not be the formal way of identifying something. An alias can be a nick name, a permutation of a name, or a shortened version of the name. For example, the aliases of basketball player “Kobe Bryant” may contain “Black Mamba”. A permutation may contain “Bryant, Kobe” and a shortened version may simply be “Kobe”. If the proper name isolation for a document isolates an alias, but does not isolate the proper name “Kobe Bryant” itself, then aliases for the topic insures Kobe Bryant can still be looked up. Similarly, aliases for the technology company “Google Inc.” topic include “Google”, “www.google.com”, and “GOOG”.

The patterns for a topic can include computed n-grams for a particular value of n (e.g., 2, 3, or 4). These can be derived from the topic's proper name. These patterns facilitate the use of n-grams that were isolated from a document, but also increase the likelihood of a good match (a good match is one that is easy to disambiguate). The longest, in terms of number of words, n-grams are chosen for a given proper name. For example, if n is 3, then “To Kill A Mocking Bird” would yield three 3-grams: “to kill a”, “Kill a mocking” and “a mocking bird”. A document then with “To Kill a Mocking Bird” in it, that the natural language parser did not isolate, would still have the n-grams “to kill a” and “kill a mocking” matched when looking the topic up in the database.

Once all of the proper names and n-grams from a document have been produced, they can be used to map to topics in the database. This can be done by forming a query over the database from the proper names that produces a union of all topics in the database that match any proper name in the proper name list. For example, if the proper name list contained the following: “kobe”, “lamar odom”, “lakers”, “the movie”, “to kill”, “kill a”, “mocking bird”, “bird is”, “odom and”, “kobe of”, “lakers went”, “the movie to”, “to kill a”, “kill a mocking”, “mocking bird is”, “bird is interesting”, “lamar odom and”, “odom and kobe”, “kobe of the”, “lakers went to.” Then, the union of topics would contain: “Kobe Bryant”, “Lamar Odom”, “Los Angeles Lakers”, and “To Kill A Mocking Bird.”

Disambiguation operation 630 can use the database of proper names to determine the correct topics for the proper names in a text document. Database-driven disambiguation specifically solves the problems of homonymy (same proper name different topic) and synonymy (same topic, different proper names) and these two factors are responsible for the high-accuracy of the tagging algorithm.

In the previous example, the proper name “Kobe” was in the isolated proper names. In the database of proper names, it is possible that “Kobe Japan” or “Kobe Beef” were also present, each with an alias of “Kobe”. In other words, “Kobe” is a homonym for each of these proper names. If this were the case, then the union of topics resulting from the proper name list query would contain the following: “Kobe Bryant”, “Kobe Japan”, “Kobe Beef”, “Lamar Odom”, “Los Angeles Lakers”, and “To Kill A Mocking Bird”.

In the text document, “Kobe Bryant” was likely the correct “Kobe” since it appears in conjunction with a teammate “Lamar Odom” and their basketball team “Los Angeles Lakers”. Various embodiments use the relationship (i.e., “roster” in this example) among the three topics to determine the correct topic. Disambiguation operation 630 determines the correct topics for the text document by choosing the correct topic among homonyms. In some embodiments, a vector space model can be applied.

A vector space is a n-dimensional Euclidean coordinate system Vₙ. If the axes in a vector space are labeled x₁, x₂, . . . , xₙ, then a point in a vector space is can represented as vector <a₁, a₂, . . . aₙ> where ai is value along the xi axis. Various embodiments of the present invention use all the proper names as a vector space Pₙ where each proper name is a dimension or axis in this vector space and n cardinality of the universe of proper names. With this model, each text document represents a vector in Pₙ that identified as vₚ.

In some embodiments, disambiguation operation 630 uses the value aᵢ for an axis xᵢ of one if the associated proper name exists in the text document. Otherwise, the value is zero. Later, in relevance scoring operation 640, the value of aᵢ will be the frequency of the corresponding proper name in the document. Clearly, this vector is sparse as the vast majority of proper names do not appear in a given text document. For simplicity, a sparse notation of component:value for any non-zero components may be used. In some embodiments, all of the topics in the database as a vector space Tₘ where each topic is a dimension in this vector space of m topics. With this model, a vector in Tₘ can be labeled as vₜ.

In some embodiments, disambiguation operation 630 uses a 1-to-1 function or mapping D: Pₙ→Tₘ. In other words, for each vector vₚ there exists exactly one vector vₜ such that D(vₚ)=vₜ where vₜ is the vector of disambiguated topics for vₚ. The disambiguation function utilizes the relationships between topics. As mentioned earlier, “Kobe Bryant” and “Lamar Odom” are roster members of the “Los Angeles Lakers”. The Lakers in essence form a natural clustering of topics around the proper name. All of players on the roster, the coaching staff, the owner, the home arena and the “Lakers” itself are a cluster and are interrelated.

The set of clusters for each topic found (e.g., using a database lookup) are first gathered. For example, suppose the following clusters were returned: Los Angeles Lakers; Japanese Food; Japanese Cities; and Classic Movies. In some embodiments, the disambiguated topics are determined using a voting system with these clusters that have been identified. A vote for a cluster topic indicates support for each topic in that cluster. The topics with the most support win. In some embodiments, for each topic or entry in the text sequence, one vote can be cast for a cluster the topic is in. The topics above would result with these votes: Los Angeles Lakers: 3; Japanese Food:1; Japanese Cities: 1; and Classic Movies: 1 These votes can be assigned to the topics that are in the clusters to get: Kobe Bryant: 3; Kobe Japan: 1; Kobe Beef: 1; Lamar Odom: 3; Los Angeles Lakers: 3; and To Kill A Mockingbird: 1.

In this case, Kobe Bryant wins against Kobe Japan and Kobe Beef since Kobe Bryant has more votes. As a result, Kobe Japan and Kobe Beef can be removed from the clusters to give a final vector of topics that include “Kobe Bryant”, “Lamar Odom”, “Los Angeles Lakers”, and “To Kill A Mockingbird”. Within the vector space then: D(<“kobe”:1, “lamar odom”:1, “lakers”:1, “the movie”:1, “to kill”:1, “kill a”:1, “mocking bird”:1, “bird is”:1, “odom and”:1, “kobe of”:1, “lakers went”:1, “the movie to”:1, “to kill a”:1, “kill a mocking”:1, “mocking bird is”:1, “bird is interesting”:1, “lamar odom and”:1, “odom and kobe”:1, “kobe of the”:1, “lakers went to”:1>)=<“Kobe Bryant”:3, “Lamar Odom”:3, “Los Angeles Lakers”:3, “To Kill A Mockingbird”:1.

Relevance scoring operation 640 determines how much the document or content relates to each disambiguated topic. One of the objectives of various embodiments is to determine the topics that are central to the discussion in the document versus the topics that simply support the discussion. Consider the following example: “The movie ‘To Kill a Mocking Bird’ is interesting. Lamar Odom and Kobe of the Lakers went to see it together last night. They both were satisfied, especially Kobe.” In this example, “they” is a co-reference to both Lamar Odom and Kobe, and “it” is a co-reference to “To Kill a Mocking Bird”. With this update, the vector vₚ is now: <“kobe bryant”:3, “lamar odom”:2, “lakers”:1, “to kill a mocking bird”:2>.

Relevance operation 640 can also apply a vector space model in one or more embodiments. Let Pₙ and Tₘ be vector spaces over the universe of proper names and a database of topics, respectively. In some embodiments, a relevance score can be determined from a 1-to-1 multivariable function R: Pₙ, Tₘ→Tₘ. For each unique pair of vectors vₚ and v_{td}, there is exactly one vector vₜᵣ such that R(vₚ, v_{td})=vₜᵣ where the component values of vₜᵣ denote the relevance of their corresponding topics in v_{td} as they are used in the text document that produced vₚ. In this case, the notation v_{td} is the topic vector from disambiguation operation 630 and vₜᵣ is the resulting topic vector for relevance scoring.

The function R is really a composition function between vₚ and v_{td}: That is, R(vₚ, v_{td})=vₚ o v_{td}=vₜᵣ where vₚ contains proper names and reference counts within the document and v_{td} contains the disambiguated topics for the proper names The composition is the assignment of reference counts to the corresponding topics and then normalizing so that the values are in a range between zero and one.

In some embodiments, the algorithm makes use of the vector space distance measure called Euclidean Norm. This is the square root of the sum of squares of the vector's individual component values. More formally, let v be a vector <a₁, a₂, . . . , aₙ>. Then the Euclidean Norm Nᵥ of v can be written as Nᵥ=|(a₁₂+a₂₂+ . . . +aₙ₂)^{1/2}|. Some embodiments, assume that all components are non-negative and at least one component is not zero. Using this assumption, a normalized vector can be defined as one whose components are divided by the Euclidean Norm giving <a₁/Nᵥ, a₂/Nᵥ, . . . , aₙ/Nᵥ>.

The normalization is the process of computing the Euclidian Norm of the reference counts and then dividing each component by that amount. In the example above, the vector to be normalized is <“kobe bryant”:3, “lamar odom”:2, “lakers”:1, “to kill a mocking bird”:2> The Euclidean Norm for this vector is (9+4+1+4)^{1/2}=(18)^{1/2}=4.2426. So, the normalized vector is vₜᵣ=<“kobe bryant”:0.7071, “lamar odom”:0.4714, “lakers”:0.2357, “to kill a mocking bird”:0.4714>.

In this example, the Lakers have a relevance of 0.2357 based on the frequency of the proper name. However, some embodiments determine that two of its players are in this article, that the relevance of the Lakers may be more than just proper name frequency. As such, the relevance can be increased because of group frequency.

The values in the relevance scoring vector vₜᵣ are the cosine similarity of each topic to the document. The cosine similarity is an angular measure of the distance between two vectors. The values can range between negative one and one with negative one being absolutely no similarity and one being an identical similarity. In some embodiments the range will be between zero and one as all vector components are positive. In the topic vector space each topic has its own topic vector: an identity vector for its dimension. The vectors for the topics in the example document are: Kobe Bryant—<“Kobe Bryant”:1>; Lamar Odom—<“Lamar Odom”:1>; Lakers—<“Los Angeles Lakers”:1>; and To Kill A Mocking Bird—<“To Kill A Mockingbird”:1>. The cosine similarity for each topic is then the dot product between the relevance scoring vector and the topic's vector. The dot product is simply the sum of the multiplication of corresponding terms in two vectors.

The clusters determined for disambiguation are also vectors that can be used to determine relevance of the cluster itself to a document in some embodiments of the present invention. A cluster vector is a normalized vector in the vector space of topics Tₘ and has a positive value for every topic that belongs in that group and zero for any value that does not belong in that group. The cluster vector, in various embodiments, can be computed by creating a vector with a value one for each member, then computing the Euclidean Norm for the vector, and finally normalizing that vector. For example, suppose a cluster contains sixteen topics. A vector of one for the corresponding topics can be created. The Euclidean Norm of this vector is (16)^{1/2}=4. Each normalized component value is then ¼=0.2500. The dot product of the relevance scoring vector with a normalized cluster vector gives the cosine similarity of the document to the cluster.

Suppose the Lakers had sixteen topics in its cluster including “Los Angeles Lakers”, “Kobe Bryant” and “Lamar Odom”. Then, each of the components has a value of 0.2500 in the normalized cluster vector: <“Los Angeles Lakers”:0.2500, “Kobe Bryant”:0.2500, “Lamar Odom”:0.2500, . . . >. Recall, that the topics in the cluster vector that are not relevant have a value of zero in the relevance scoring vector. Some embodiments compute the dot product of the relevance scoring vector to the group vector as follows: Cosine Similarity=(0.2500)*(0.7071+0.4714+0.2357)=0.3535. This value then says the “Los Angeles Lakers” team has a relevancy value to the document of 0.3535 whereas the “Los Angeles Lakers” proper name has a relevance value of 0.2237.

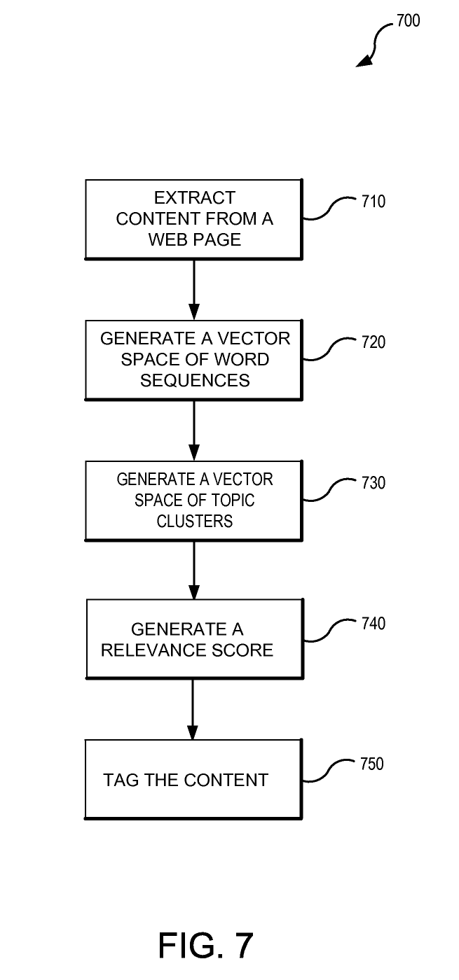

FIG. 7 is a flow chart illustrating exemplary operations 700 for tagging content in accordance with one or more embodiments of the present invention. One or more of the operations shown in FIG. 7 can be performed using web crawler module 104, isolation engine 420, query module 440, scoring module 450, and/or tagging module 455. Extraction operation 710 extracts content from a document. In some cases, the document can be an HTML document such as a web page. Once the content has been extracted, word generation operation 720 generates a vector space of word sequences and cluster generation operation 730 generates a vector space of topic clusters. Using the vector of topic clusters and word sequences, scoring operation 740 can generate relevance scores. Tagging operation 750, then tags the content with the relevance scores.

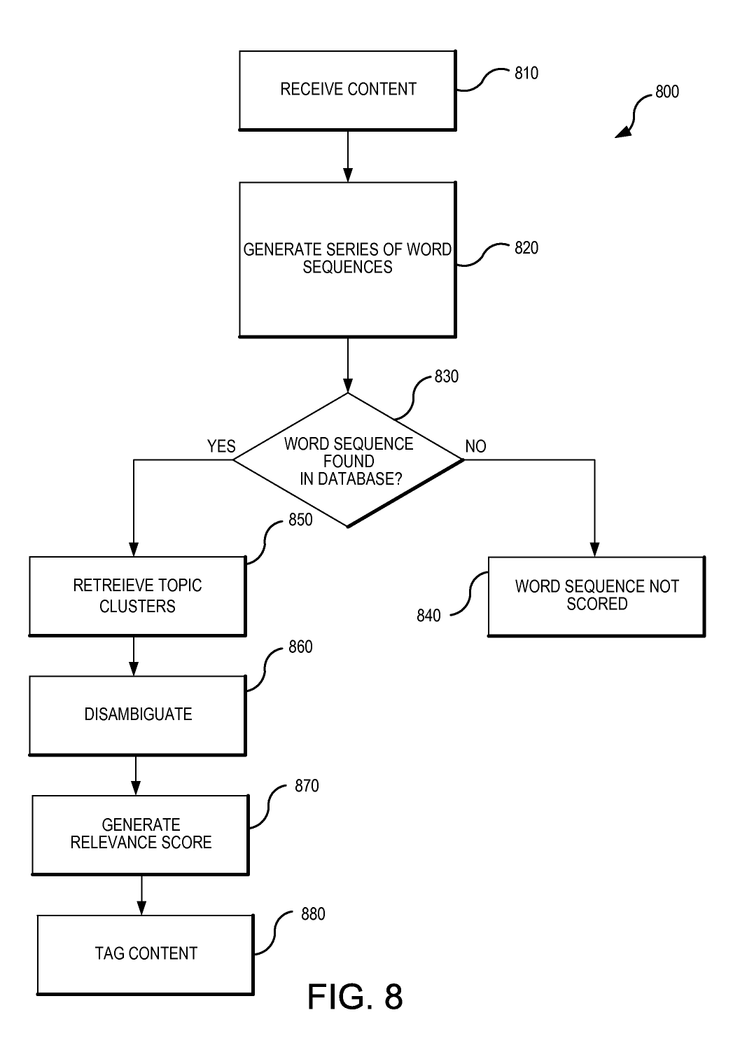

FIG. 8 is a flow chart illustrating exemplary operations 800 for tagging content in accordance with various embodiments of the present invention. As illustrated in FIG. 8, receiving operation 810 receives a content to be evaluated. The content may be an HTML document where the comments and other non-content related items have been removed. Once the content has been received, generation operation 820 generates a series of words from the content. This can be done, for example, using isolation engine 420. Determination operation 830 determines if each entry is found in a database or table. If determination operation 830 determines that no entry of the word sequence is found in the database, then the sequence is not scored as illustrated by step 840.

If an entry is found, the retrieving operation 850 retrieves the topic clusters associated with the entry. In some embodiments, clusters relating to aliases and/or synonyms are also returned. Once a list of clusters has been generated, disambiguation operation 860 removes any topics that are determined to be not relevant to the content. Disambiguation operation 860, then branches to scoring operation 870 where a relevance score can be computed. Tagging operation 880, then tags the content.

### Exemplary Computer System Overview

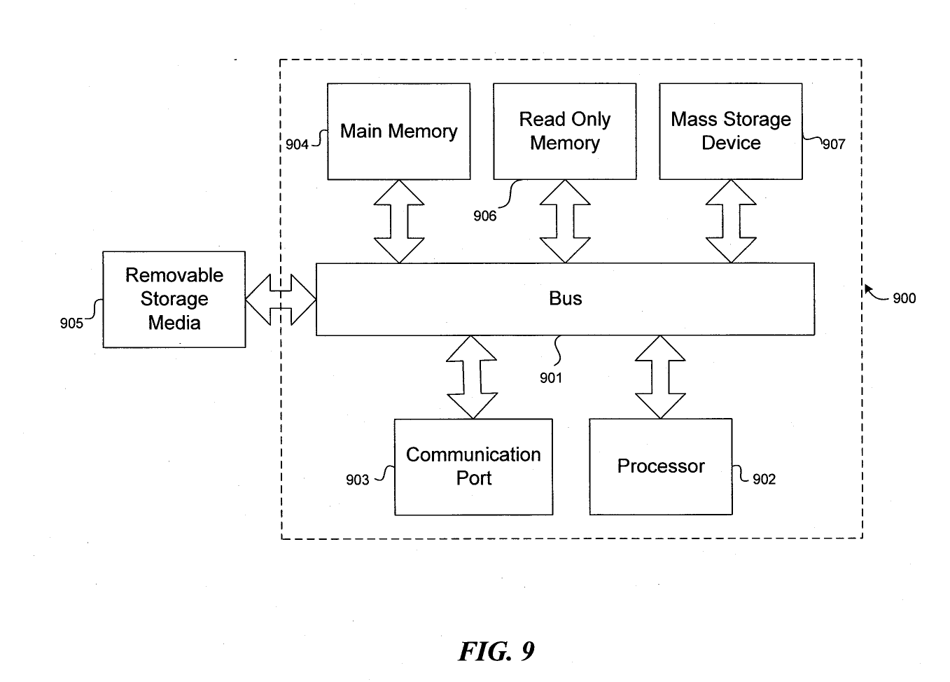

Embodiments of the present invention include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 9 is an example of a computer system 900 with which embodiments of the present invention may be utilized. According to the present example, the computer system includes a bus 905, at least one processor 910, at least one communication port 915, a main memory 920, a removable storage media 925, a read only memory 930, and a mass storage 935.

Processor(s) 910 can be any known processor, such as, but not limited to, an Intel® Itanium® or Itanium 2® processor(s), or AMD® Opteron® or Athlon MP®processor(s), or Motorola® lines of processors. Communication port(s) 915 can be any of an RS-232 port for use with a modem based dialup connection, a 10/100 Ethernet port, or a Gigabit port using copper or fiber. Communication port(s) 915 may be chosen depending on a network such a Local Area Network (LAN), Wide Area Network (WAN), or any network to which the computer system 900 connects.

Main memory 920 can be Random Access Memory (RAM), or any other dynamic storage device(s) commonly known in the art. Read only memory 930 can be any static storage device(s) such as Programmable Read Only Memory (PROM) chips for storing static information such as instructions for processor 910.

Mass storage 935 can be used to store information and instructions. For example, hard disks such as the Adaptec® family of SCSI drives, an optical disc, an array of disks such as RAID, such as the Adaptec family of RAID drives, or any other mass storage devices may be used.

Bus 905 communicatively couples processor(s) 910 with the other memory, storage and communication blocks. Bus 905 can be a PCI/PCI-X or SCSI based system bus depending on the storage devices used.

Removable storage media 925 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM).

The components described above are meant to exemplify some types of possibilities. In no way should the aforementioned examples limit the scope of the invention, as they are only exemplary embodiments.

In conclusion, the present invention provides novel systems, methods and arrangements for cluster-based relevance scoring. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof. Therefore, the above description should not be taken as limiting the scope of the invention, which is defined by the appended claims.

What is claimed is:

1. A method comprising:
generating a first vector space of word sequences from content extracted from a web page;
generating a second vector space of topic clusters associated with the content; and
tagging the content based on a relevance scoring vector generated by projecting the first vector space of word sequences into the second vector space of topic clusters.

2. The method of claim 1, further comprising extracting the content from a web page using a web crawler.

3. The method of claim 1, wherein generating the second vector space of topic clusters includes determining a relevance distribution of the topic clusters to the content and removing one or more of the topic clusters from the second vector space.

4. The method of claim 3, wherein the relevance distribution is created using a voting algorithm.

5. The method of claim 1, wherein generating the second vector of topic clusters includes generating the topic clusters from topics associated with each word sequence in the first vector space of word sequences.

6. The method of claim 1, wherein the tagging includes a topical tag based on a cosine similarity of the content to the second vector space of topic clusters.

7. A system comprising:
an isolation engine configured to receive content and generate, using a processor, a first series of proper names found within the content;
a topic cluster database having stored thereon a plurality of entries, wherein each of the plurality of entries have one or more topic clusters;
a query module communicably coupled to the isolation engine and configured to access the topic cluster database to determine a second series of topic clusters related to the first series of proper names; and
a scoring module communicably to receive the first series of proper names and the second series of topics clusters and generate relevance scores.

8. The system of claim 7, wherein the isolation engine includes a natural language parsing module to generate the first series of proper names.

9. The system of claim 8, wherein the isolation engine includes a sequence generator to generate n-grams from the content.

10. The system of claim 7, wherein the database includes a list of synonyms for each entry and for each query the database also associates topical clusters associated with the synonyms.

11. The system of claim 10, wherein the list of synonyms includes alias and patterns for each entry.

12. The system of claim 7, further comprising a disambiguation module determines a topical relevance of the second series of topic clusters to the content and removes one or more unrelated topic clusters from the second series of topic clusters based on the topical relevance.

13. The system of claim 12, wherein the disambiguation module uses a vector space model to determine the relevance.

14. The system of claim 7, further comprising a tagging module configured to tag the content based on the relevance scores.

15. The system of claim 7, wherein the series of proper name entries include reference to a person, an event, a significant date, a movie, a song, a musical group, a book, a play, a social group, a company, an internet address, an activity, a city, a state, a country, or a county,

16. A method comprising:
generating a set of topical clusters associated with a text sequence having a plurality of entries;
generating, using a processor, a topical score for each topical cluster, wherein for each entry in the text sequence a vote is assigned to one of the topical clusters; and
determining a relevance score for each of the plurality of entries in the text sequence.

17. The method of claim 16, further comprising removing at least one of the topical clusters from the set of topical clusters based on the topical score.

18. The method of claim 16, further comprising isolating the set of text sequences from a document.

19. The method of claim 18, further comprising generating the document by extracting text from a web page.

20. The method of claim 18, wherein isolating the list of text sequences includes generating a first list using natural language parsing.

21. The method of claim 20, wherein isolating the list of text sequences includes generating a set of n-gram word sequences from the first list and updating the first list to include the set of n-gram word sequences.

22. The method of claim 16, further comprising mapping the document into a set of disambiguated topics to generate the topic clusters.
